(19) United States
(12) Patent Application Publication
(10) Pub. No.: US 2009/0167470 A1
(43) Pub. Date: Jul. 2, 2009

(54) ELECTRIC SWITCH

(76) Inventors: Oscar Rolando Avila Cusicanqui, Baja-Sucre (BO); Jose Carlos Tinoco Soares, Jr., Sao Paulo (BR)

Correspondence Address: AKERMAN SENTERFITT, P.O. BOX 3188, WEST PALM BEACH, FL, 33402-3188, US

(21) Appl. No.: 12/280,550

(22) PCT Filed: Feb. 23, 2007
(86) PCT No.: PCT/BR2007/000051

§ 371 Date: Dec. 4, 2008

(30) Foreign Application Priority Data
Feb. 24, 2006 (BR) PI 0600680-9
Feb. 15, 2007 (BR) C1 0600680-9

(51) Int. Cl. H01H 9/20; H01H 51/06

(52) U.S. Cl. 335/170; 335/179

(57) ABSTRACT

Electric switch which comprises a general structure (11), in which there is use of coils (1) enabled with alternated and rectified DC current, which are combined with the permanent magnets (2), being that the coils (1) and magnets (2) are set up in parallel in a fixed core (3), made of steel or ferrite plates, which is made up of a crown (4), on which the coils (1) are set up, legs (5) through which circulate the magnetic flows induced by the coils (1) as well as the magnetic flows from the permanent magnets (2); the coils (1) being supplied through a supply line (12).

This report discusses a Privilege of Invention patent that describes an electric switch of the type used in electrical installations in general. The switch in question is distinguished from switches in prior art by the fact that it combines electric coils with the use of permanent magnets in parallel with steel plate fixed core.

As is general knowledge, there is a type of electric switch that uses the generation of a magnetic field, produced by coils integrated in the switch itself to enable the mechanical effect of increasing the force of displacement of a mobile component that drags with it the electric contacts that are interposed to the fixed contacts, thus closing the circuit and determining the switch's activation. This switch type can basically have two constructive configurations, called type “E” core and type “U” core.

This switch type, activated manually, electrically or electronically, depends on the force of attraction of the coils to obtain the effect of keeping the electric contacts coupled, being that said coupling force is dimensioned in function of the switch's physical size, which is also influenced by the load with which the switch will operate so to speak.

Therefore, the development of a new switch model of the type described above and belonging to prior art is in a certain way restricted and limited to the various different parameters, being that among the most important is the load that will pass through it, a fact that prevents, according to current technology, reduction of the device's physical dimensions.

Within this context, one of the objectives of this Privilege of Invention patent is to promote an electric switch of the type that uses electric coils to generate a magnetic field used to promote attraction of the mobile component that closes the electric contacts, where said switch is improved by incorporating auxiliary means that promote a natural increase of said mobile component's force of attraction.

Another objective of this Privilege of Invention patent is to provide an electric switch of the type that uses electric coils, such as that described above, where the fact of incorporating auxiliary means that promote increase in the mobile component's natural force of attraction that closes the electric circuit allows reduction in the physical dimensions of the switch so to speak, with obvious gains in terms of manufacturing and marketing cost reduction.

The improved electric switch object of this Privilege of Invention patent can be better understood in all its details from the figures listed below, where:

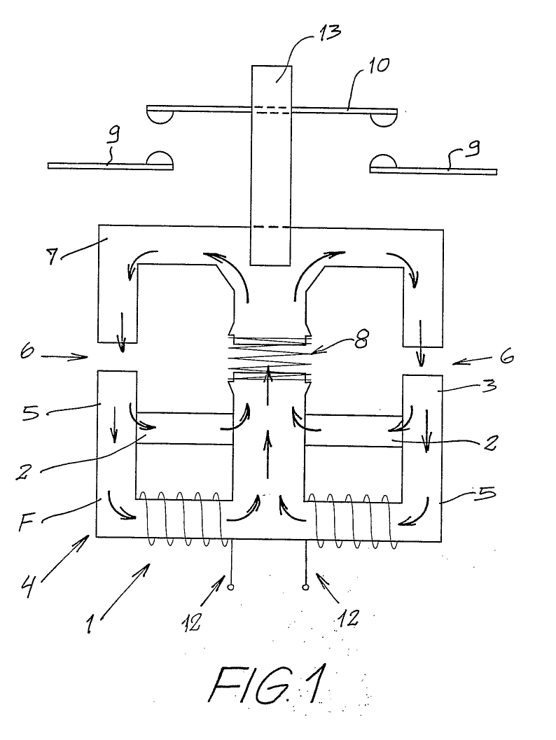

FIG. 1 shows a schematic view of the improved switch discussed herein, in its type “E” modality, in its “enabled” mode;

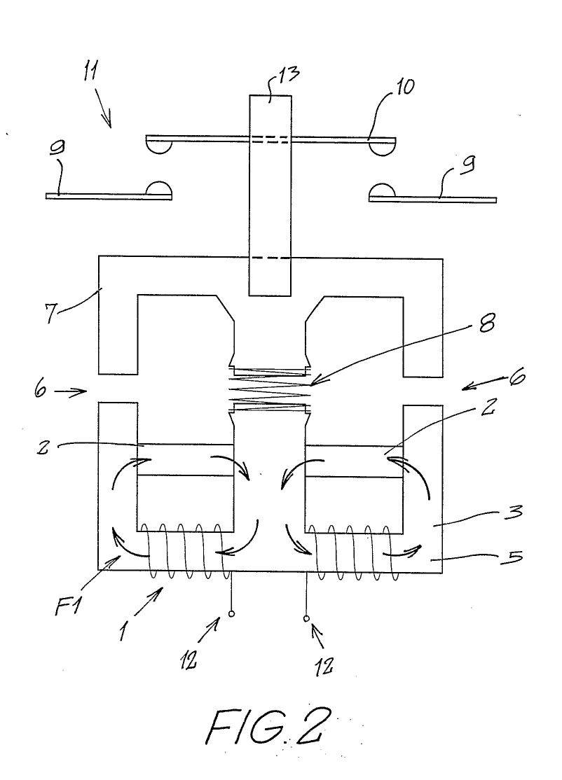

FIG. 2 shows a schematic and plan view of the switch in FIG. 1;

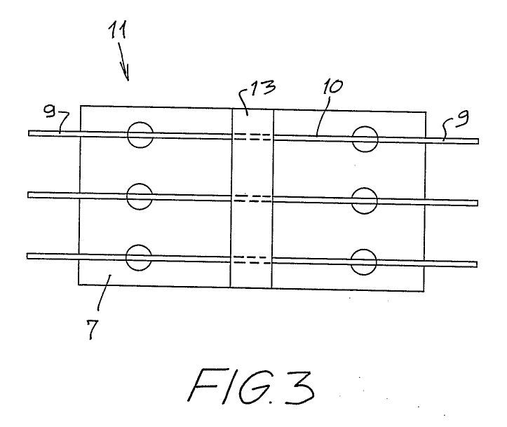

FIG. 3 shows a view of the proposed switch, portrayed in its “disabled” condition;

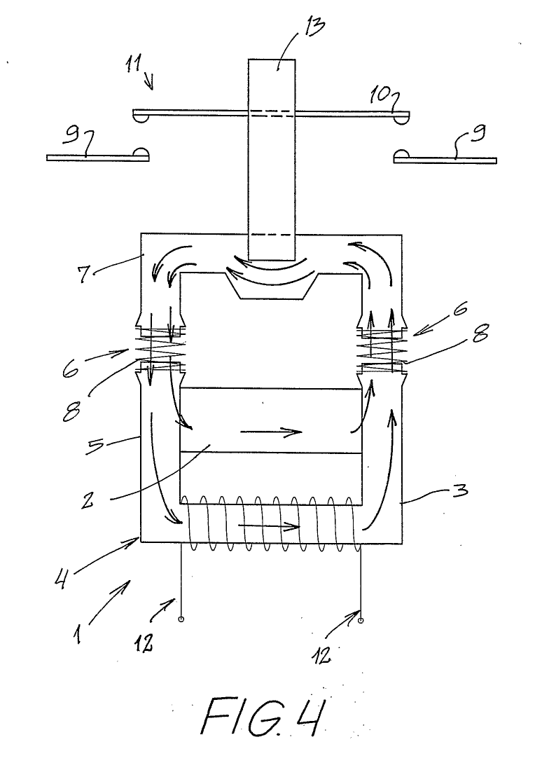

FIG. 4 shows a schematic view of the improved switch discussed herein, in its type “U” modality, in its “enabled” condition;

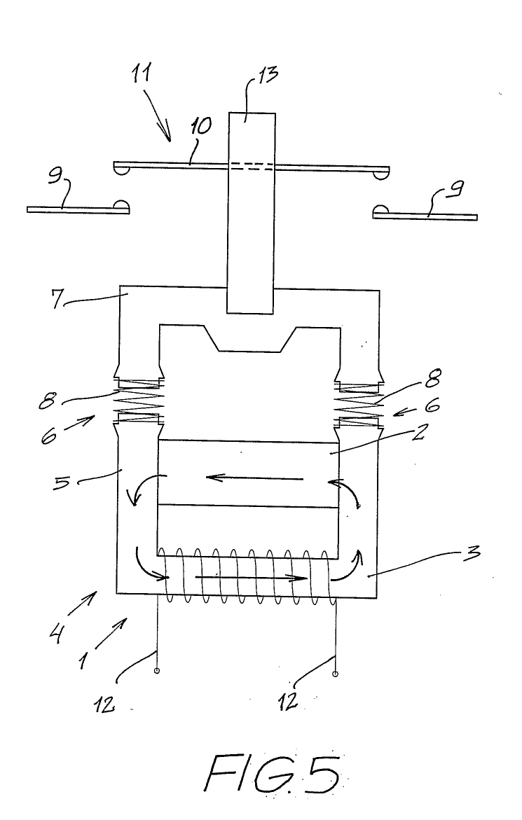

FIG. 5 shows a schematic and plan view of the switch in FIG. 4;

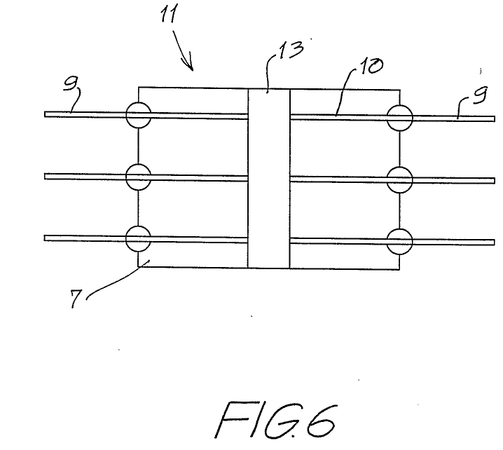

FIG. 6 shows a view of the switch proposed in FIGS. 4 and 5, portrayed in its “disabled” condition; and

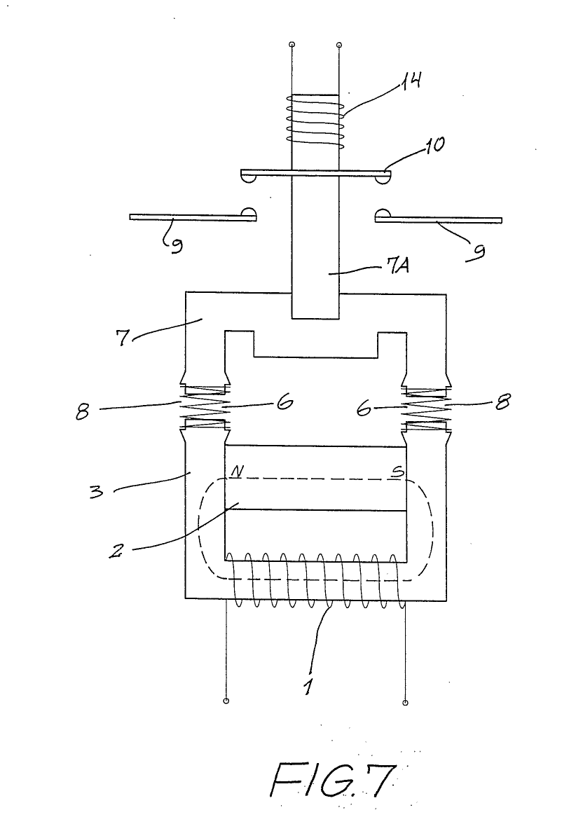

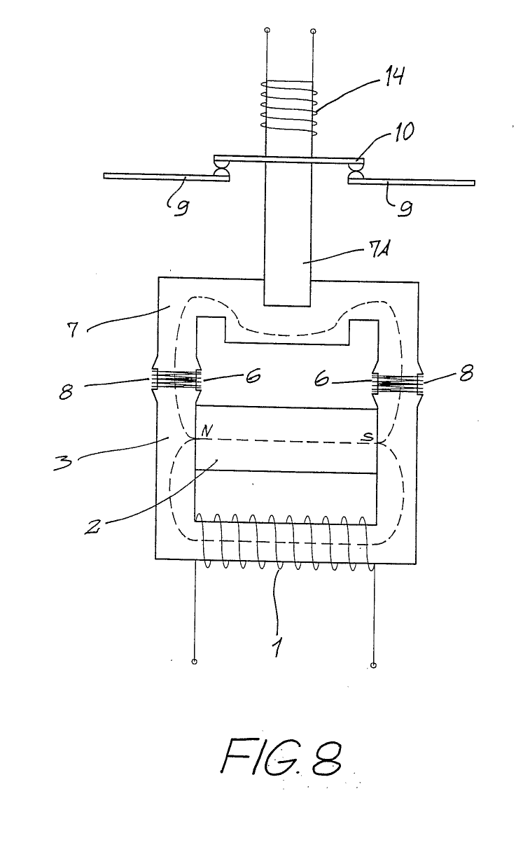

FIGS. 7 and 8 show a variant of the switch in question, portrayed in its “disabled” condition in FIG. 7 and “enabled” in FIG. 8.

According to the abovementioned figures, in the improved switch object of this Privilege of Invention patent, coils 1 are used, enabled with alternated and rectified DC current and permanent magnets 2, being that the coils 1 and magnets 2 are set up in parallel in a fixed core 3 made of steel or ferrite plates, which is made up of the crown 4 (on which the coils 1 are set up), legs 5 through which circulate the magnetic flows induced by the coils 1 as well as the magnetic flows from the permanent magnets 2, being that this set of flows indicated generically as F crosses the space between the “armature gaps” 6.

Likewise, the magnets 2 are set up between the legs 5 of the core 3, in parallel with the coils 1, as can be seen in the figures showing this Privilege of Invention patent.

In the already mentioned core 3, the direction of flows from the magnets 2 and their polarities are the same as those of the coils 1, being that when the coils 1 are activated (see FIGS. 1 and 4), two flows F (from the coils and magnets) have the same polarities, causing them to repel each other, said flows F thus moving in direction of the movable armature 7 through the armature gap 6 spaces, as shown in FIGS. 1 and 4 mentioned, which represent the switch (in its two modalities), in the “enabled” condition.

On combining both flows (from the coils and magnets) in the core's polar areas, the force of attraction that will move the movable armature 7 until the space between the armature gap 6 is closed is substantially greater than that obtained with the coils 1 alone, arriving at a value that results in more than double the force. In other words, with the same energy usually employed by the coils 1 to produce their own magnetic flows F in the polar areas, the magnetic flows F from the magnets 2 are also obtained, thus increasing the force of attraction needed for the switch's operation by more than twice that usually obtained.

When the switch is in its “enabled” condition, the armature gap 6 closes, being that the fixed 9 and mobile 10 electric contacts are joined, thus allowing the load current to pass.

On the other hand, while the coils 1 of the switch are disabled, the forces produced by the coils 1 themselves disappear, as well as the force combined with the magnetic forces generated by the magnets 2, condition in which the movable armature 7 returns to its original position through the use of force from the return springs 8 connected to the movable armature 7, creating by virtue of this, once again, the armature gap 6 space with the consequent disabling of electric contacts 9 and 10, cutting circulation of the load current.

When the coils 1 are disabled, the flow from the magnets 2 enter a toroid or closed circuit configuration, as shown in FIGS. 2 and 5, where said flow type is indicated as Fl, causing the switch as a whole to enter its “disabled” condition.

The switch described herein has the advantage over conventional switches due to the fact that by using the flow from the permanent magnets 2 combined with the flow generated by the coils 1, it is possible to obtain a substantially high actuating force with the same electric power current value normally used to enable the already mentioned coils.

The switch described herein can have two basic configuration types, to wit: “E” configuration type, shown in FIGS. 1, 2 and 3 and “U” configuration type, shown in FIGS. 4, 5 and 6.

The characteristic of combining flows generated by coils 1 and permanent magnets 2 allows said devices to be physically dimensioned with reduced size and with greater potency in force of attraction when compared to switches from prior art (also known as “Linear Actuators”).

The drawings showing this patent also indicate the general structure of the switch, indicated by reference number 11, supply of the coils 1, through reference number 12; and the part for support of the mobile electric contacts, indicated as 13.

FIGS. 7 and 8 show a variant of the switch in question, which works with rectified current of the full wave, or rectified half wave, or still direct current (DC), being that said switch is formed by a movable armature 7 and a fixed core 3 in “d” and “U” shape, which has a coil 1 in its crown part, the coil 1 being in parallel with the permanent magnet 2 located between the legs of said fixed core 3, being that the permanent magnet 2 has a cross-shaped section. The movable armature 7 has a steel rod 7A that works as core of a coil 14 that has the shape of a ring and is located behind said movable armature 7.

The movable armature 7 incorporates a set of return springs 8 that naturally keeps it at a distance from the fixed core 3 when the load current is not necessary.

Therefore, when the switch is in “open” state, the flow of the permanent magnet 2 is in a closed magnetic path, directly from the cross configuration, thus, the magnetic flow is in a toroid condition or state (as shown in FIG. 7) and there is no magnetic flow in the poles and armature gaps 6.

When coil 1 of the fixed core 3 is energized with enough current to produce flow in the armature gap 6, the flow of said permanent magnet 2 is also forced outward of the toroid and directed toward the armature gap 6, producing the force of attraction proportional to the density of the flow from the magnet and said coil, thus creating a magnetic force of attraction proportional to both densities of the flows capable of forcing the movable armature 7 and springs 8 (elasticity), determining that the mobile contact 10 touch the fixed contacts 9, allowing the current to pass with a certain resistance. Therefore, at this very moment, when said electric contacts (9 and 10) are closed, the current from the fixed core 3 is demobilized, being that at this time, and due to the movable armature 7 being in direct contact with the fixed core, the flow from said permanent magnet (from said cross where the coil is) is produced in parts almost equal to the flow, thus forming a closed magnetic circuit in the shape of an “8”, as shown in FIG. 8.

Due to the fact that this flow from said permanent magnet is closing in a circuit directly related to the movable armature 7, it has enough magnetic force to keep said movable armature connected to the poles of the fixed core 3, thus keeping the electric contacts in a closed state to allow the current to pass for an indefinite time, thus, in this state, the switch does not consume electric power to keep the contacts closed.

Actually, when said resistance current is not enough, it can be cut by coil 14 in shape of a ring located behind the rod 7A, upon enough electric current to produce the magnetic density that attracts the rod 7A, thus forcing, at the same time, said movable armature 7 to separate from the poles of the fixed core 3 to its original opening state.

A characteristic of this switch consists of the fact that the switch uses the magnet's flow together with the coil's flow to produce more force of attraction in the armature gap, when the flow of said coil is acting alone.

Another characteristic of this switch is that when the switch is in the “closed” state, the electric contacts can allow the resistance current to pass, without consuming electric power, since said magnet flow is closed and has a circuit directly related to the movable armature, thus keeping the switch working in closed state.

Another characteristic of this switch is that it consumes power only for short periods of time, when the coil 14 of the fixed core 3 is energized to force the movable armature 7 to close the armature gap 6 and when the coil 14 is energized to force said movable armature 7 to move far away from the fixed core 3 to its original position of open state. In this switch, the coil 14 of the fixed core 3 does not consume power when the switch is in the “closed” state for long periods of time, and said coil must also be long due to the fact that the flow from the magnet fixed in said movable armature 7 is strongly linked to the poles of said fixed core 3 uniformly, without any fluctuation observed in electric coils. In this switch, said electric contacts, for this reason, have permanent and uniform contacts that can increase their service life.

In this case, due to the fact that the permanent magnet gives addition force to said switch, the movable armature will close the armature gap 6 more quickly, thus preventing sparks in the contacts, thus giving them a longer service life.

1. “ELECTRIC SWITCH”, comprising a general structure (11), where there is a fixed core (3) made of steel or ferrite plates, said fixed core receiving the assembly of a movable armature (7), where the mobile contacts (10) are arranged that are liable to close circuit with fixed contacts (9), being that between said core (3) and the movable armature (7), there is at least one return spring (8) that maintains, with the switch off, the armature gap (6) spaces; the mobile contacts (10) are arranged in a support part (13); said core (3) comprising a crown (4), legs (5), through which magnetic flows circulate; characterized by the fact of making use of coils (1) enabled with alternated and rectified DC current, which are combined with permanent magnets (2), being that the coils (1) and magnets (2) are set up in parallel in a fixed core (3), made of steel or ferrite plates, which comprises the crown (4), where the coils (1) are assembled, legs (5) through which circulate the magnetic flows induced by the coils (1) as well as the magnetic flows from the permanent magnets (2); the coils (1) being supplied through a supply line (12).

2. “ELECTRIC SWITCH”, according to claim 1 characterized by the fact that the set of magnetic flows (F) generated by the coils (1) as well as the permanent magnets (2) cross the space of the “armature gaps” (6) when the switch is enabled.

3. “ELECTRIC SWITCH”, according to claim 1 characterized by the fact that the magnets (2) are assembled between the legs (5) of the core (3) in parallel with the coils (1).

4. “ELECTRIC SWITCH”, according to claim 1 characterized by the fact that in the core (3), the direction of flow from the magnets (2) and their polarities are the same as those of the coils (1), being that when the coils (1) are enabled, both flows (F) from the coils (1) and from the magnets (2) have the same polarities, causing them to repel, directing said flows (F) to the movable armature (7) through the armature gap (6) spaces, thus determining the condition of “enabled” switch, being that on combining both flows (F) in the polar areas of the core, the force of attraction that will move the movable armature (7) until the space between armature gap (6) is closed is magnified.

5. “ELECTRIC SWITCH”, according to claim 4 characterized by the fact that when the switch is in its “enabled” condition, the armature gap is closed, time in which the fixed (9) and mobile (10) electric contacts are joined, thus allowing the load current to pass.

6. “ELECTRIC SWITCH”, according to claim 4 characterized by the fact that inversely, when the coils (1) of the switch are disabled, the forces produced by the coils themselves as well as the combined force with the magnetic forces generated by the magnets (2) disappear, condition in which the movable armature (7) returns to its original position using the force of the return springs (8) linked to the mobile iron, thus creating the armature gap (6) space with consequent disabling of the electric contacts (9) and (10), cutting the load current's circulation.

7. “ELECTRIC SWITCH”, according to claim 4 characterized by the fact that when the coils (1) are disabled, the flow from the magnets enter a toroid or closed circuit configuration, this flow being indicated as (F1), causing the switch as a whole to enter its “disabled” condition.

8. “ELECTRIC SWITCH”, according to claim 1 characterized by the fact that it can have a type “E” configuration.

9. “ELECTRIC SWITCH”, according to claim 1 characterized by the fact that it can have a type “U” configuration.

10. “ELECTRIC SWITCH”, according to claim 1 characterized by the fact that it comprises a switch that also works with full wave or half wave rectified current, or still direct current (DC), being that said switch is formed by a movable armature (7) and a fixed core (3) in the shape of a “d” and “U”, which has a coil (1) in its crown part, the coil (1) being in parallel with a permanent magnet (2) located between the legs of said fixed core (3), being that the permanent magnet (2) has a cross-shaped section; the movable armature (7) has a steel rod (7A) that acts as the core of a coil (14) with the shape of a ring and that is located behind said movable armature (7); the movable armature (7) incorporates a set of return springs (8) that naturally keeps it at a distance from the fixed core (3) when the load current is not necessary.

11. “ELECTRIC SWITCH”, according to claim 10 characterized by the fact that when the switch is in “open” state, the flow from the permanent magnet (2) is in a closed magnetic path, directly from the cross configuration, therefore, the magnetic flow is in a toroid condition or state, being that there is no magnetic flow in the poles and armature gaps (6); when the coil (1) of the fixed core (3) is energized with enough current to produce flow in the armature gap (6), the flow from said permanent magnet (2) is also forced outside outward of the toroid and directed toward the armature gap (6), producing the force of attraction proportional to the density of the flow from the magnet and from said coil, thus creating a magnetic force of attraction proportional to both densities of the flows capable of forcing the movable armature (7) and the springs (8) (elasticity), determining that the mobile contact (10) touch the fixed contacts (9), allowing the current to pass with a certain resistance. Therefore, at this very moment, when said electric contacts (9 and 10) are closed, the current from the fixed core (3) is demobilized, being that at this time, and due to the movable armature (7) being in direct contact with the fixed core, the flow from said permanent magnet (from said cross where the coil is) is produced in parts almost equal to the flow, thus forming a closed magnetic circuit in the shape of an “8”.

12. “ELECTRIC SWITCH”, according to claim 10 characterized by the fact that when the permanent magnet is closing in a circuit directly related to the movable armature (7), having enough magnetic force to keep said movable armature connected to the poles of the fixed core (3), thus keeping the electric contacts in a closed state to allow the current to pass for an indefinite time, condition in which the switch does not consume electric power to keep the contacts closed, being that said resistance current is not necessary, it can be cut by the coil (14) in the shape of a ring located behind the rod (7A), upon enough electric current to produce the magnetic density that attracts the rod (7A), thus forcing, at the same time, said movable armature (7) to separate from the poles of the fixed core (3) to its original opening state.
